(19) United States
(12) Patent Application Publication
(10) Pub. No.: US 2016/0005051 A1
(43) Pub. Date: Jan. 7, 2016

(54) MOBILE ELECTRONIC VERIFICATION OF DIGITAL SIGNATURES

(71) Applicant: RedKomodo Inc., San Francisco, CA (US)

(72) Inventors: Kyle TAYLOR, Charlotte, NC (US); Patrick A. HILL, Charlotte, NC (US)

(21) Appl. No.: 14/722,784

(22) Filed: May 27, 2015

Related U.S. Application Data
(60) Provisional application No. 62/020,124, filed on Jul. 2, 2014.

(51) Int. Cl. G06Q 30/00; H04L 9/32

(52) U.S. Cl. CPC G06Q 30/0185; H04L 9/3247

(57) ABSTRACT

Embodiments of the invention are directed to systems, methods, and computer program products for facilitating a business transaction via a mobile device using verified information of a party to the business transaction. The methods, systems, and computer program products allow for conducting a business transaction using a mobile device and a central repository of verified party information. In this way, party information provided to an electronic document involved in the business transaction may be verified by selecting a party signature information having embedded therein verified party information from the central repository.

This nonprovisional application claims the benefit of U.S. Provisional Application No. 62/020,124, filed Jul. 2, 2014, which is incorporated by reference herein in its entirety.

### BACKGROUND

In the present environment, companies and other entities engage consumers or other companies for facilitating business transactions in a number of ways. In some instances when the companies and/or entities engage in the business transaction, there is sometimes insufficient information for verifying an identity or an authority of one or more parties involved in the business transaction.

### BRIEF DESCRIPTION OF THE DRAWINGS

Having thus described embodiments of the invention in general terms, reference will now be made to the accompanying drawings, where:

FIG. 1 is a flowchart illustrating a general process flow for establishing an electronic profile of a user or entity for facilitating a business transaction, in accordance with an embodiment of the invention.

FIG. 2 is a detailed process flow for facilitating a business transaction, in accordance with some embodiments of the invention.

FIG. 3 is a block diagram of a mobile device associated with a user for facilitating a business transaction, in accordance with embodiments of the invention.

FIG. 4 is a mixed system and process flow for facilitating a business transaction with verified user information, in accordance some embodiments of the invention.

FIG. 5 is a mixed system and process flow for facilitating a business transaction with verified user information, according to a first embodiment.

FIG. 6 is a mixed system and process flow for facilitating a business transaction with verified user information, according to a second embodiment.

FIG. 7 is a mixed system and process flow for facilitating a business transaction with verified user information, according to a third embodiment.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the invention may take the form of a computer program product having a computer-readable storage medium having computer-executable program code embodied in the medium.

Reference in this specification to “one embodiment” or “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any suitable computer-readable medium may be utilized. The computer-readable medium may be, for example but not limited to, an electronic, magnetic, optical, electromagnetic, infrared, or semiconductor system, apparatus, or device. For example, in one embodiment, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or other tangible optical or magnetic storage device.

Computer-executable program code for carrying out operations of the invention may be written in object oriented, scripted and/or unscripted programming languages such as Java, Perl, Smalltalk, C++, SAS, SQL, or the like. However, the computer-executable program code portions for carrying out operations of the invention may also be written in conventional procedural programming languages, such as the “C” programming language or similar programming languages.

Some embodiments of the invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The computer-executable program code may also be loaded onto a computer or other programmable data processing apparatus to cause a series of operational steps to be performed on the computer or other programmable apparatus to produce a computer-implemented process such that the computer-executable program code which executes on the computer or other programmable apparatus provides steps for implementing the functions/acts specified in the flowchart and/or block diagram block(s). Alternatively, computer-implemented steps or acts may be combined with operator or human implemented steps or acts in order to carry out an embodiment of the invention.

In general terms, embodiments of the invention are directed to systems, methods, and computer program products for verification of one or more parties to a transaction using a mobile device. In one embodiment, the invention relates to an application on a mobile device that is used to facilitate a business transaction and authenticate or verify at least one party to the business transaction. A first step in implementing the invention, in one embodiment, may include creating an electronic profile containing various information related to one or more of the parties involved in a business transaction facilitated via a mobile device. In the context of a business, the information could be various documents regarding corporate structure, corporate constitutional documents, corporate agreements, financial statements, corporate minutes, shareholder agreements, compliance certifications, tax forms, client reporting, investor information, client ownership structure and the like. These documents and/or data can then be made available to a verification server or the like that is used in verifying or authenticating an agent of the business or the business, itself. In the context of an individual, the information may include personal information associated with the user, such as the individual's name, physical address, email address, phone number, social security number, date of birth, phone number, social security number, answers to challenge questions, biometric information (i.e., fingerprint, voice recording, retina scan, facial scan), financial account information (i.e., credit card information, bank account information, and the like). Once the electronic profile is created, the invention may use the profile information in verifying one or more of the parties to the business transaction.

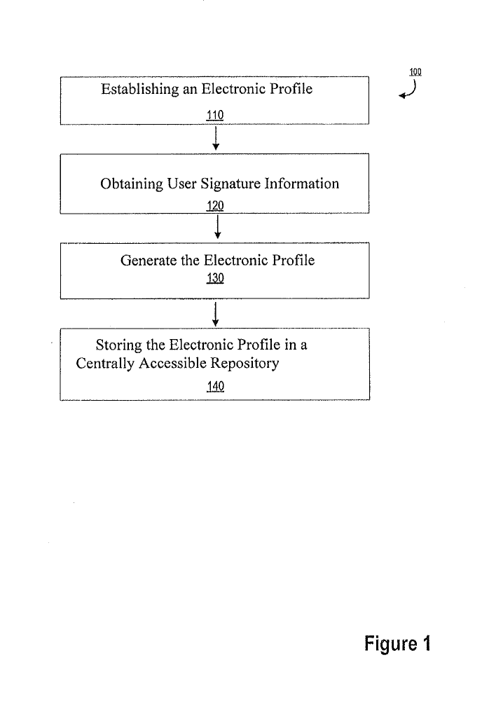

FIG. 1 illustrates a general process flow 100 for establishing an electronic profile of a user or entity for facilitating a business transaction, in accordance with an embodiment of the invention. The electronic profile may be established at any time including prior to the business transaction or during the business transaction. As represented by block 110, establishing the electronic profile, in some embodiments, first involves acquiring or receiving information relating to a user, such as a business entity or an individual. The acquired information or received information may include different types of information that identifies the user and/or may be used to verify the identity of the user and/or the ability of the user to complete the business transaction. In some embodiments, the information includes a name of the user, a image of the user (i.e., photograph of the user's face or business logo), financial account information (i.e., credit card information, bank account information, and the like), biometric information (i.e., voice, fingerprint, facial, retina information, and the like), business documents, corporate agreements, corporate structure, corporate or individual authorization documents, and the like.

As represented by block 120, contemporaneously or at another time, user signature information may be also obtained. A system executing process flow 100 may receive a physical or electronic signature from the user. In one embodiment, the system may receive the electronic signature in a number of ways including via a mobile device involved in the business transaction. In such an embodiment, the system may receive an input of the user signature when the user creates a signature by applying a stylus or his finger to an input device of a mobile device. In this way, an actual signature of the user is received by the system to be associated with the electronic profile. In some embodiments, the system may receive pre-existing signature of the user, such as an electronic copy of the user's actual signature. In such an embodiment, the user may transmit the electronic signature to the system via a computer device.

As represented by block 130, the system executing process flow 100 generates the electronic profile of the user based on receiving the user information. Once the user has provided the information that the system requires for establishing the profile, the system generates a profile for the user. The user may view the profile and edit the profile if any changes are required to the information. As such, the user may continually update the profile, as necessary, when his information changes over time.

As represented by block 140, once the profile is generated, the system executing process flow 100 stores the electronic profile information. In some embodiments, the system stores the electronic profile and associated information in a central repository accessible to one or more parties involved in the business transaction. The repository maybe maintained by a third party not directly involved in or outside of the business transaction or one or more of the parties involved in the business transaction.

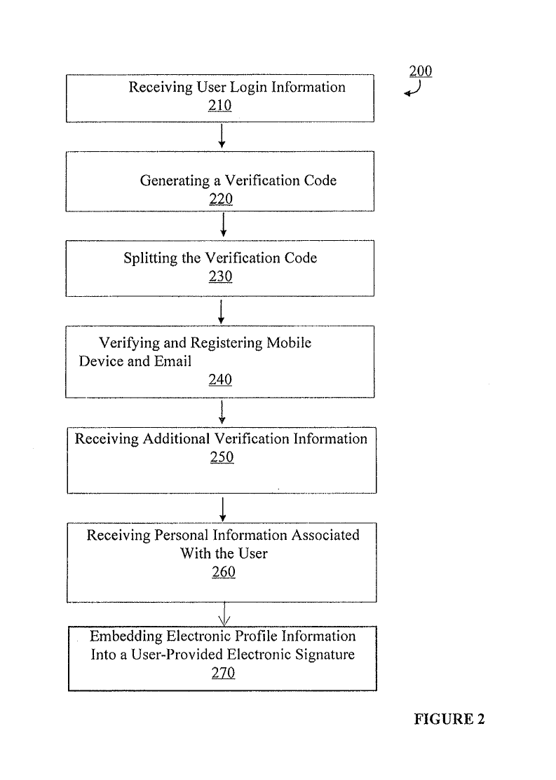

FIG. 2 illustrates a detailed process flow 200 for facilitating a business transaction, in accordance with some embodiments of the invention. In one embodiment, the business transaction is facilitation via a business application accessible to the mobile device of one or more of the parties involved in a business transaction using the mobile device. The business application, in some embodiments, is linked to one or more other applications associated with the mobile device or one or more of the parties involved in the transaction. For example, in one embodiment, the business application used for facilitating the business transaction is associated with a user account or user application. The user account or user application may be a number of different types of accounts or applications (e.g., Google Play, Apple ID, and the like). The user application or user account, in some embodiments, has pre-existing user information associated therewith or otherwise, in the setup of the user application or user account required user information for verifying the identification or authority of the user. Also, the user may have created a user ID and password for the user application or user account. Thus, the user may have a pre-existing user ID and/or password associated with a pre-existing user account and/or user application.

At block 210, a system executing process flow 200 receives user login information. In some embodiments, user login information may include a pre-existing or newly created user ID and password that is used for accessing the system used for facilitating the business transaction. The user login information may be received via mobile device involved in the business transaction. The user login information may be associated with another user account or user application.

Still at block 210, once the user has logged into the system, in some embodiments, additional verification of the user is required for establishing an electronic profile for the user. In such an embodiment, the system may prompt the user for additional verification information in addition to the user login information. For example, the system may prompt the user for a phone number associated with a mobile device involved in the business transaction and an email address of the user. The user may provide input associated with the phone number and email to the system in a number of ways including by inputting the information to an input device associated with the mobile device.

At block 220, in some embodiments, upon receiving the additional verification information from the user, the system executing process flow 200 generates a code that is used for verification and/or registration of the mobile device and/or the email address of the user. The generated code may be any kind of code. In some embodiments, the generated code is an alphanumeric code. In one embodiment, the code is a completely numeric or alphabet code or a combination of numbers, letters, and/or symbols and spaces.

At block 230, in some embodiments, the system executing process flow 230 bifurcates or otherwise splits the generated code and transmits the one or more portions of the code to the user provided email address and/or phone number associated with the mobile device. The one or more portions of the code may be provided to the mobile device of the user via text message (sms) or phone call (voice recording).

At block 240, the system verifies and/or registers the user-provided email address and/or the mobile device based on receiving input from the user comprising the one or more portions of the generated code. For example, in some embodiments, the system successfully verifies or registers the mobile device and the email address when the user replies to both the email and the text message that include the one or more portions of the generated code. Upon receiving the responses to the email and text message, the system may combine the portions of the code and compare or match the combined portions of the code to the previously generated code. When the system identifies a match between the combined code or otherwise, the portions of the code, the system automatically verifies and/or registers the mobile device and email address which then may be used in facilitating a business transaction. In some embodiments, the system verifies the email address and mobile device simultaneously.

At block 250, the system executing process flow 200, receives even further additional verification information. In one embodiment, the system receives financial account information of the user, such as credit card information. The credit card information may include a credit card number, expiration date of the credit card, and/or a credit card verification value (CVV) or security code. Upon receiving the financial account information, the system compares address information or other information associated with the financial account to user-provided address information. When the system determines a match between the user-provided address information and the address information associated with the financial account, the user is allowed to progress to the next step for creating the electronic profile.

At block 260, the system executing process flow 200, receives personal information associated with the user. In some embodiments, the personal information includes date of birth of the user, social security number, fingerprint, picture, audio voice recording, facial image, and the like. This information is stored in the electronic profile of the user and may be individually used or collectively used for authenticating the user.

Still at block 260, the system receives a signature from the user. In some embodiments, the system receives the signature when the user signs with a finger or some other input device, such as a stylus. In one embodiment, the system receiving the signature of the user completes the verification process as it relates to the information that a user must provide for creating an electronic profile. The system may then create a signature file for the electronic signature of the user and store the signature file. The signature file may be stored separately from the electronic profile of the user or in some embodiments, the signature file is stored together with or within the electronic profile of the user. The benefit is storing the signature file and electronic profile together is that both files may be easily located for verification. In the embodiments where the signature file is stored separately from the electronic profile of the user, metadata may be associated with either or both of the signature file and/or the electronic profile that associates the files or causes the files to correspond to each other.

At block 270, the system executing process flow 200 embeds electronic profile data into the user-provided electronic signature. This feature may be called a “SignBundle.” In some embodiments, the system selectively embeds information from the electronic profile of the user into the electronic signature in a number of ways. In one embodiment, the system electronically associates one or more elements of data from the electronic profile of the user with the electronic signature. In such an embodiment, the electronic signature may be a selectable input feature that when selected by a party to the business transaction involving the user, displays the one or more elements of data from the electronic profile. In another embodiment, the system embeds information from the electronic profile of the user into the electronic signature by linking the electronic signature directly to the electronic profile of the user or otherwise, to separately created data table with selected electronic profile information. In such an embodiment, upon selecting the electronic signature, the electronic profile of the user is automatically generated such that a party to the business transaction may verify the identity or authority of the user based on viewing or otherwise using the electronic profile information.

The system executing process flow 200 may then access the user's “SignBundle” for any documentation purposes. For example, the system may access the user's “SignBundle” for automatically populating an electronic agreement via the mobile device. The system may also verify any data inserted into the electronic agreement by the user or otherwise, to verify the validity of the contents of the document.

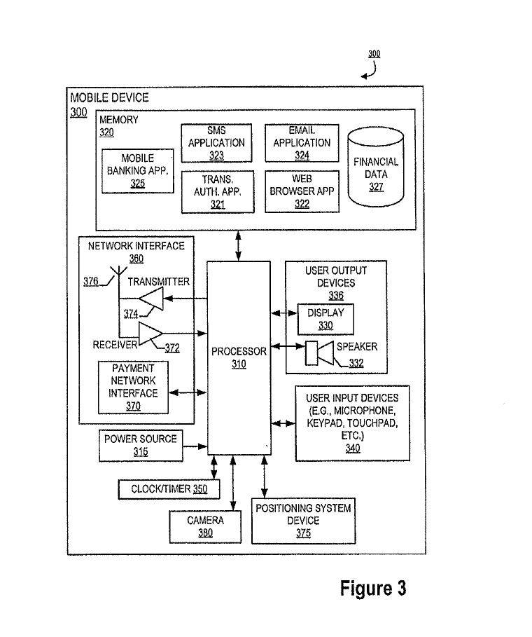

Referring now to FIG. 3, the mobile device 300 associated with the user or part to a business transaction involving the mobile device is described more specific detail. FIG. 3 provides a block diagram illustrating a mobile device 300 in accordance with embodiments of the invention. In one embodiment of the invention, the mobile device 300 is a mobile telephone. However, it should be understood that a mobile telephone is merely illustrative of one type of mobile device 300 that may benefit from, employ, or otherwise be involved with embodiments of the invention and, therefore, should not be taken to limit the scope of embodiments of the invention. Other types of mobile devices 300 may include portable digital assistants (PDAs), tablets, pagers, mobile televisions, gaming devices, laptop computers, cameras, video recorders, audio/video player, radio, GPS devices, or any combination of the aforementioned.

The mobile device 300 generally includes a processor 310 communicably coupled to such devices as a memory 320, user output devices 336, user input devices 340, a network interface 360, a power source 315, a clock or other timer 350, a camera 380, and a positioning system device 375. The processor 310, and other processors described herein, generally includes circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 350. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. In some embodiments where network 350 is a wireless telephone network, the signals may include signaling information in accordance with the air interface standard of the applicable cellular system of the wireless telephone network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN), near field communication network, or other communication/data networks.

The network interface 360 may also include a payment network interface 370. The payment network interface 370 may include software, such as encryption software, and hardware, such as a modem, for communicating information to and/or from one or more devices on a network 350. For example, the mobile device 300 may be configured so that it can be used as a credit or debit card by, for example, wirelessly communicating account numbers or other verification information to point of transaction computer system.

As described above, the mobile device 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the mobile device 300 to receive data from user, may include any of a number of devices allowing the mobile device 300 to receive data from a user, such as a keypad, keyboard, touch-screen, touchpad, microphone, mouse, joystick, other pointer device, button, soft key, and/or other input device(s). The user interface may also include a camera 380, such as a digital camera.

The mobile device 300 may also include a positioning system device 375 that is configured to be used by a positioning system to determine a location of the mobile device 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate location of the mobile device 300. In other embodiments, the positioning system device 375 includes a proximity sensor or transmitter, such as an RFID tag, that can sense or be sensed by devices known to be located proximate a merchant or other location to determine that the consumer mobile device 300 is located proximate these known devices.

The mobile device 300 further includes a power source 315, such as a battery, for powering various circuits and other devices that are used to operate the mobile device 300. Embodiments of the mobile device 300 may also include a clock or other timer configured to determine and, in some cases, communicate actual or relative time to the processor 310 or one or more other devices.

The mobile device 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile device 300 described herein. For example, the memory 320 may include such applications as a transaction verification application 321, conventional web browser application 322, a SMS application 323, and email application 324 and/or mobile banking application 325. These applications also typically provide a graphical user interface (GUI) on the display 330 that allows user to communicate with a point of transaction computer system and/or financial institution computer system. In some embodiments, memory 320 may store financial data 327. Financial data 327 may comprise data or information relating to transactions of a user, such as credit card information, debit card information, bank account information, and/or information necessary to validate transactions involving the user. In some embodiments, financial data 327 may include the stored information that is used to determine offers for products during a user shopping experience.

The memory 320 can also store any of a number of pieces of information, and data, used by the mobile device 300 and the applications and devices that make up the mobile device 300 or are in communication with the mobile device 300 to implement the functions of the mobile device 300 and/or the other systems described herein.

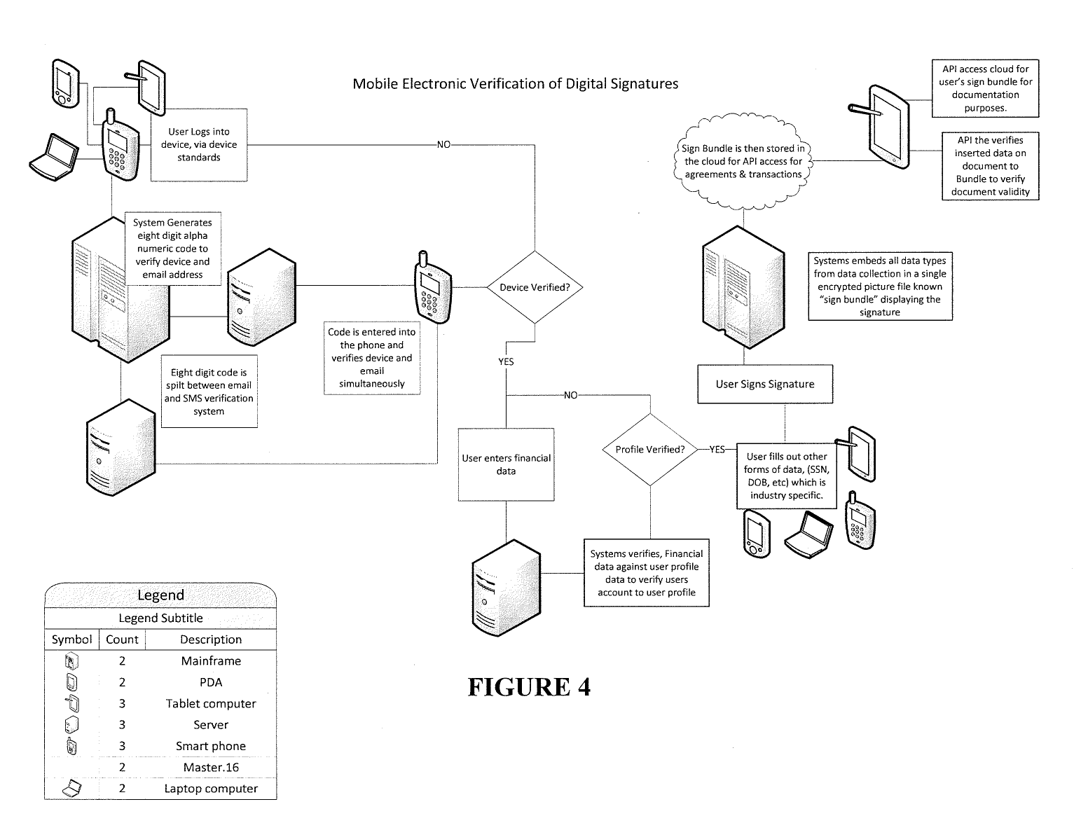

FIG. 4 illustrates an example mixed system environment and process flow for facilitating a business transaction with verified user information, in accordance some embodiments of the invention. As shown in FIG. 4, the mixed system environment includes user device(s) 402 (including mobile device 300), system server 404, email server 406, mobile device server 408, and a second system server 410. These features and elements of FIG. 4 may be used to implement any of the process flows described herein including process flows 100 and 200. It will be understood that although some of the features of FIG. 4 are shown separately, some of these elements may be combined or some of the processes or features of various elements or systems may be completed by one system or various other systems shown within FIG. 4.

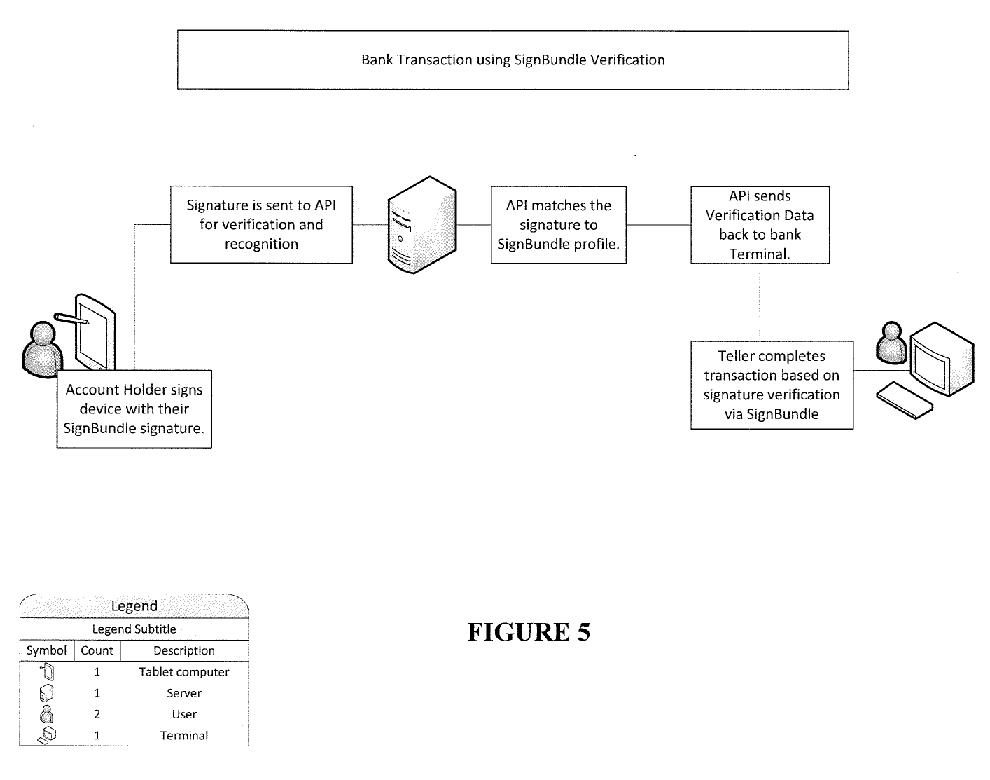

FIGS. 5-7 illustrate example mixed system environments and process flows for facilitating a business transaction with user verified information in different circumstances, in accordance with various embodiments of the present invention. For instance, FIG. 5 illustrates a banking transaction using verified user information. FIG. 5 includes a user, a mobile device of a user, user information verification server, and banking system. The banking system may include an agent system which may be used by an agent of the bank to facilitate a banking transaction with the user.

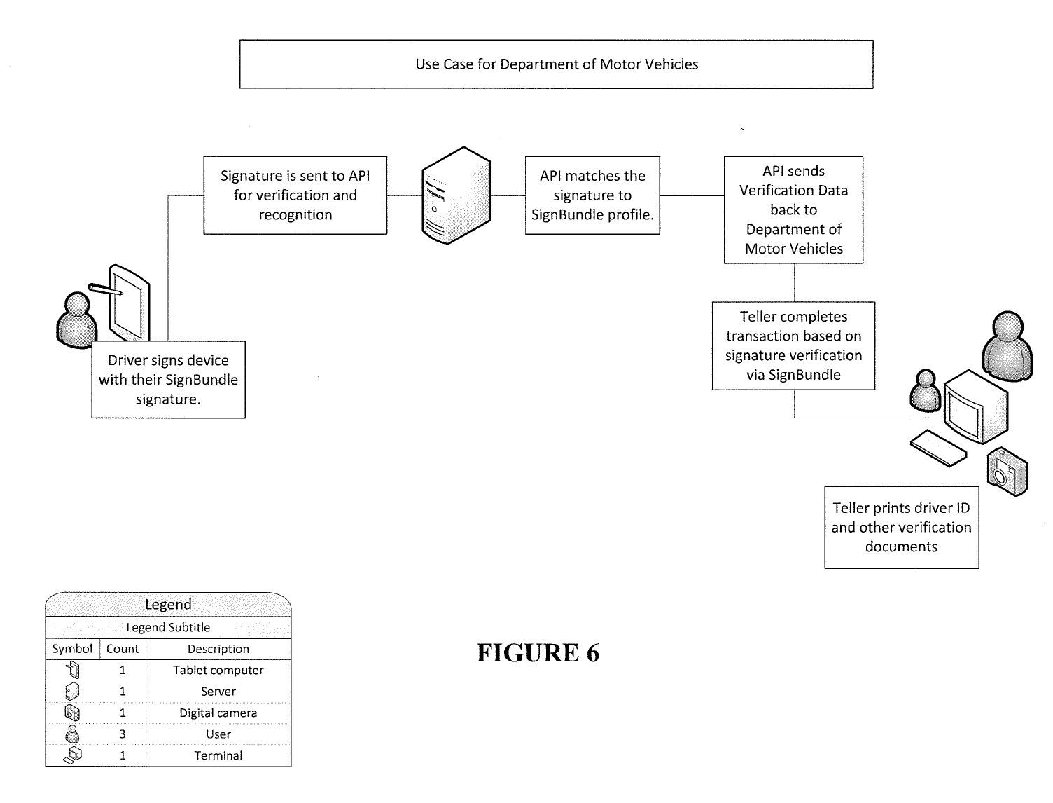

FIG. 6 illustrates a department of motor vehicles (DMV) transaction using verified user information. FIG. 6 includes a user, a mobile device of the user, verification server, and DMV system. The DMV system may include an agent system that may be used by an agent or employee of the DMV to facilitate a DMV transaction with the user.

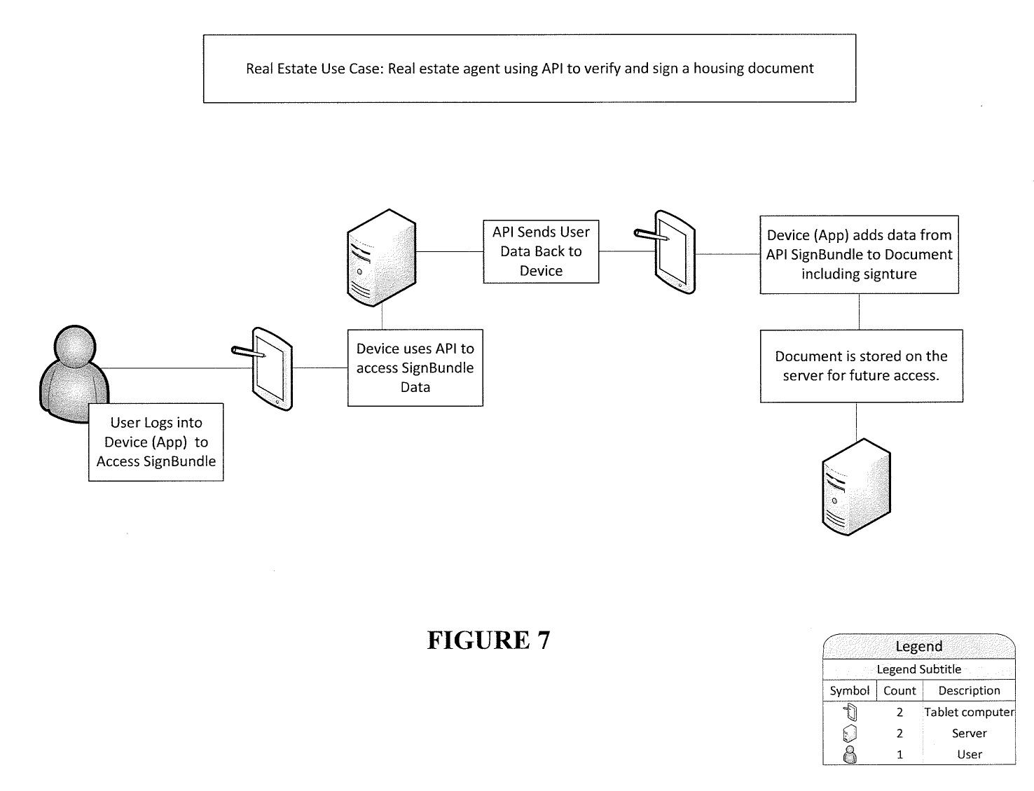

FIG. 7 illustrates a real estate transaction user verified user information. FIG. 7 includes a user, a user mobile device, a verification server, and a real estate transaction system (not shown).

The present invention can be implemented as a method, as a system, as computer instruction codes, as an apparatus and/or combinations of any of the above. Some of the claims of the application may be drafted in means-plus-function format. While the means recited in these claims can be implemented by any number of systems, devices, computer program code, etc., that may meet the functions outlined by the recited means.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed:

1. A system for facilitating a business transaction via a mobile device and using verified information of one or more of the parties involved in the business transaction, the system comprising:
a mobile device, the mobile device comprising a communication interface, a processing device, and a display;
a storage device accessible to the mobile device, the storage device comprising information for verifying a party involved in the business transaction;
a non-transitory computer-readable medium comprising computer executable instruction code, that when executed causes the processing device to:
facilitate the business transaction by:
receiving at least one business document for the business transaction;
accessing via the storage device an electronic profile associated with at least one party involved in the business transaction;
receiving authentication information from the at least one party;
comparing the authentication information to verification information of the electronic profile; and
completing the business transaction based on the comparison.

2. A non-transitory computer program product according to claim 1.

3. A method for performing one or more steps according to claim 1.
